(19) United States
(12) Patent Application Publication
(10) Pub. No.: US 2008/0108387 A1
(43) Pub. Date: May 8, 2008

(54) Carrying case with integrated input-output device

(76) Inventor: Jason Entner, Brooklyn, NY (US)

Correspondence Address: COOPER & DUNHAM, LLP, 1185 AVENUE OF THE AMERICAS, NEW YORK, NY, 10036, US

(21) Appl. No.: 11/603,470

(22) Filed: Nov. 21, 2006

Related U.S. Application Data
(60) Provisional application No. 60/857,418, filed on Nov. 6, 2006.

(51) Int. Cl. H04B 1/38

(52) U.S. Cl. 455/557

(57) ABSTRACT

This invention provides a carrying case for holding a personal audio player or cellular phone, wherein the case is of a size sufficient to hold up to twice the volume of the personal audio player or of the cellular phone, and the case comprises an input-output interface compatible with the personal audio player or cellular phone.

This application claims the benefit of U.S. Provisional Application No. 60/857,418, filed Nov. 6, 2006, the contents of which are incorporated herein by reference into the subject application.

### BACKGROUND OF THE INVENTION

This invention relates generally to the field of carrying cases for personal audio players and cellular telephones. More, particularly, this invention relates to an apparatus that incorporates an integrated input-output device into a carrying case for a personal audio player and/or a cellular telephone.

Personal audio players (i.e. MP3 players) and cellular phones are commonplace in today's society. However, most of these devices are designed for use by one person at a time. Personal audio players normally output sound to a headset or earphones, making it difficult for use by more than one individual at a time. Similarly, cellular phones require the user to hold the phone directly to his or her ear or alternatively attach a headset or earphones.

The present invention is an apparatus intended to eliminate the need for a headset or earphones in order to listen to the audio output of a personal audio player or cellular phone, thus facilitating shared use of the player or phone. The present invention can also provide further benefits, such as protection for the device and increased portability.

### SUMMARY OF THE INVENTION

This invention provides a carrying case for a personal audio player or for a cellular phone comprising an input-output device.

The advantages and features of the invention will become apparent to those skilled in the art upon consideration of the following description of the invention. The invention may be best understood by reference to the following description.

### BRIEF DESCRIPTION OF THE FIGURES

FIG. 1

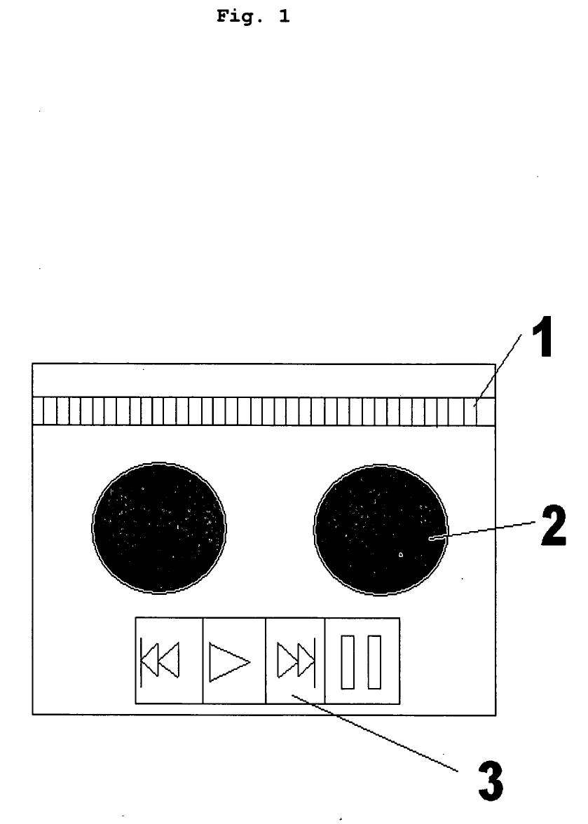

Front view of an embodiment of the claimed invention. This embodiment comprises a top flap lid with zipper enclosure 1, two speakers 2 and an exteriorly located control panel 3 for the device to be carried therein.

FIG. 2:

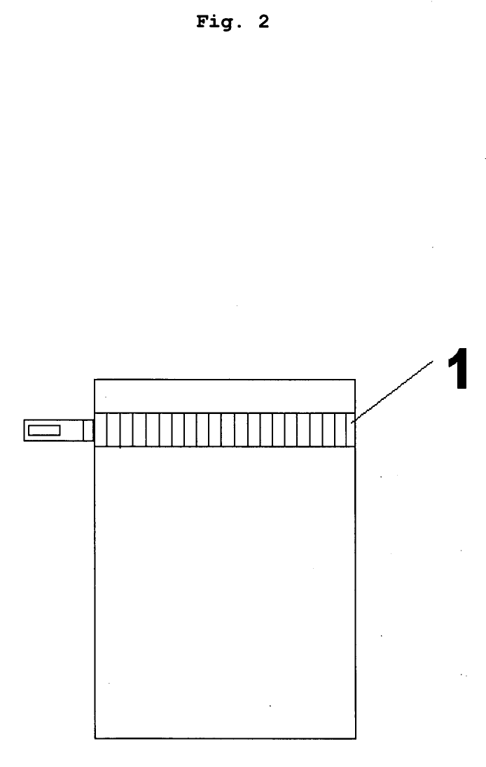

Side view of an embodiment of the claimed invention showing zipper enclosure 1.

FIG. 3:

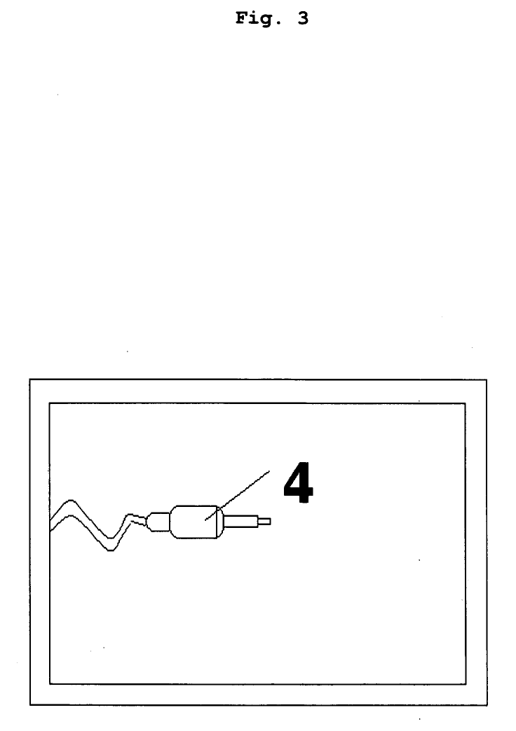

Top view of an embodiment of the interior of the carrying case. Top flap of the carrying case is not pictured. Interior of the carrying case comprises an input output interface 4 appropriate for the personal audio device or cellular phone to be carried therein.

### DETAILED DESCRIPTION OF THE INVENTION

While this invention is susceptible of embodiment in many different forms, specific embodiments will herein be described in detail, with the understanding that the present disclosure is to be considered as an example of the principles of the invention and not intended to limit the invention to the specific embodiments shown and described.

This invention provides a case for holding a personal audio player or a cellular phone, wherein the case is of a size sufficient to hold up to twice the volume of the personal audio device or of the cellular phone, and wherein the case comprises speakers and an input-output interface compatible with the personal audio player or cellular phone. The term “volume” is intended to mean the volume based on the exterior measurements of the personal audio device or cellular phone, i.e., the product of the length, width and height of the personal audio device or cellular phone. The interface can be wireless, e.g., using Bluetooth®, or hardwired, e.g., wires between the label and the device's input output jack or other suitable jack. Information regarding Bluetooth® technology can be found at the “Official Bluetooth® Wireless Info Site.” In the preferred embodiment, the input-output device is integrated into the case, such that the personal audio player or cellular phone, when placed within the case, can be connected to the input-output interface.

In one embodiment, the input-output device is connected to the personal audio player or cellular phone via the personal audio player or cellular phone's audio output jack. In one embodiment, the case comprises an amplifier for amplifying the signal from the personal audio player or cellular phone. In another embodiment, the case comprises a microphone.

The size of the claimed invention will depend on the size of the personal audio player for which it is intended, i.e., for which the input-audio device is compatible. In one embodiment, the case is approximately the size of the personal audio player or cellular phone.

The claimed invention can be constructed of many materials. In one embodiment, the case is constructed of a rigid material, such as plastic. In another embodiment, the case is constructed of a flexible material, such as vinyl, neoprene, leather or silicone. In one embodiment, the case can be padded or insulated to protect the contents from shock, temperature, water, dust or other potentially damaging conditions. In one embodiment, the case has a lid such that the opening through which the device is placed is able to be closed. In another embodiment, the opening can be sealed, for example, via zipper, Velcro, magnets and snaps.

In one embodiment, the case comprises a window to permit viewing of the contents within. In another embodiment, the case comprises an exteriorly-located control panel allowing one to access and control the personal audio player or cellular phone without removing said player or phone from the case. In the preferred embodiment, the integrated control panel will provide all or some of the commands as the control panel on the personal audio player or cellular phone. In one embodiment, the controls are accessed via push buttons. In one embodiment, one function is associated with pushing one button. In another embodiment, one function is associated with pushing two or more buttons simultaneously. In another embodiment, the case comprises an alternative or additional power source for the personal audio device or cellular phone.

In another embodiment, the case comprises a light source(s). The light source(s) can be located in the interior or exterior of the case, or both. In one embodiment, activation of the light source(s) is synchronized with the audio output of the personal audio device or cellular phone. In one embodiment, the light source(s) can synchronously flash with the rhythm of the music from the personal audio player. In another embodiment, the light source(s) can activate upon reception of an incoming call to the cellular phone. In another embodiment, the case comprises a mirror. In another embodiment, the case comprises a device for attaching itself to another object (e.g., clothing, a backpack or purse), such as a strap, clip or carabiner. In another embodiment, the case comprises a keychain.

Accordingly, it is intended that the present invention embrace all such alternatives, modifications and variations that fall within the scope of the appended claims.

What is claimed is:

1. A case for holding a personal audio player or cellular phone, wherein the case is of a size sufficient to hold up to twice the volume of the personal audio player or of the cellular phone, and wherein the case comprises speakers and an input-output interface compatible with the personal audio player or cellular phone.

2. The case of claim 1, wherein the interface is wireless.

3. The case of claim 1, wherein the interface is hardwired to the personal audio device or cellular phone.

4. The case of claim 1, wherein the input-output interface is integrated into the case, such that the personal audio player or cellular phone, when placed within the case, can be connected to the input-output interface.

5. The case of claim 3, wherein the input-output interface is connected to the personal audio player or cellular phone via the personal audio player or cellular phones's audio output jack.

6. The case of claim 1, wherein the case comprises an amplifier for amplifying the audio signal from the personal audio player or cellular phone.

7. The case of claim 1, wherein the case comprises a microphone.

8. The case of claim 1, wherein the case is approximately the size of the personal audio player or cellular phone.

9. The case of claim 1, wherein the case is constructed of a rigid material.

10. The case of claim 9, wherein the rigid material is plastic.

11. The case of claim 1, wherein the case is constructed of a flexible material.

12. The case of claim 11, wherein the flexible material is vinyl, neoprene, leather or silicone.

13. The case of claim 1, wherein the case is padded or insulated to protect the contents.

14. The case of claim 1, wherein the case comprises a window of transparent material to permit viewing of the contents within.

15. The case of claim 1, wherein the case comprises an exteriorly-located control panel allowing one to access and control the personal audio player or cellular phone without removing from the case.

16. The case of claim 15, wherein the control panel provides all or some of the commands as the control panel on the personal audio player or cellular phone.

17. The case of claim 1, wherein the case comprises an alternative or additional power source for the personal audio device or cellular phone.

18. The case of claim 1, wherein the case comprises a light source.

19. The case of claim 18, wherein the light source is located in the interior or exterior of the case, or both.

20. The case of claim 18, wherein activation of the light source is synchronized with the audio output of the personal audio device or cellular phone.

21. The case of claim 1, wherein the case comprises a mirror.

22. The case of claim 1, wherein the case comprises a device for attaching itself to another object

23. The case of claim 1, wherein the case comprises a keychain.
